(19) United States
(12) Patent Application Publication
(10) Pub. No.: US 2021/0286354 A1
(43) Pub. Date: Sep. 16, 2021

(54) INFORMATION PROCESSING APPARATUS, INFORMATION PROCESSING METHOD, AND SYSTEM

(71) Applicant: TOYOTA JIDOSHA KABUSHIKI KAISHA, Toyota-shi (JP)

(72) Inventors: Takahiro HARADA, Chiryu-shi (JP); Teppei NISHIGUCHI, Nisshin-shi (JP); Kazuki KOMORIYA, Toyota-shi (JP); Tomoaki IHARA, Toyota-shi (JP); Miyu HIGASHIMURA, Toyota-shi (JP); Toshihiro NAKAICHI, Nagoya-shi (JP); Kazunobu OKASAKA, Toyota-shi (JP); Ryo HATTORI, Kariya-shi (JP); Yohei TANIGAWA, Toyota-shi (JP); Ryohei KIMBARA, Toyota-shi (JP); Hiroshi NAKAMURA, Nagoya-shi (JP)

(73) Assignee: TOYOTA JIDOSHA KABUSHIKI KAISHA, Toyota-shi (JP)

(21) Appl. No.: 17/171,202

(22) Filed: Feb. 9, 2021

(30) Foreign Application Priority Data
Mar. 16, 2020 (JP) 2020-045719

(51) Int. Cl. G05D 1/00; G05D 1/02; G06Q 10/02

(52) U.S. Cl. CPC G05D 1/0027; G05D 1/0212; G05D 2201/0216; G06Q 10/02; G05D 1/0022

(57) ABSTRACT

An information processing apparatus that manages a plurality of first units separable from vehicles respectively owned by a plurality of users, capable of autonomous drive, and each capable of being coupled to a second unit having space for accommodating baggage, includes a control unit. The control unit is configured to acquire first unit information containing information on a non-use period that is a period during which the first unit is not schedule to be used by the user, for each of the plurality of first units, acquire second unit information containing information on the number of the second units to be used in delivery of baggage in a predetermined period, and select, from among the plurality of first units, the first unit to be coupled to the second unit for use in delivery of baggage in the predetermined period based on the first unit information and the second unit information.

### INCORPORATION BY REFERENCE

The disclosure of Japanese Patent Application No. 2020-045719 filed on Mar. 16, 2020 including the specification, drawings and abstract is incorporated herein by reference in its entirety.

### BACKGROUND

### 1. Technical Field

The disclosure relates to an information processing apparatus, an information processing method, and a system.

### 2. Description of Related Art

Japanese Unexamined Utility Model Application Publication No. 03-007089 (JP 03-007089 U) describes an automobile. The automobile includes a power unit, an operation unit, and a coupler. The power unit includes a steering mechanism and a drive wheel that is driven by a drive mechanism. The operation unit includes an operator seat and an operation device for operating the drive mechanism and steering mechanism of the power unit and includes only non-drive wheels. The coupler couples the power unit and the operation unit so that the power unit and the operation unit can be separated from each other.

### SUMMARY

The disclosure provides effective usage of a first unit, separable from a vehicle owned by a user and capable of autonomous drive, for delivery of baggage.

A first aspect of the disclosure relates to an information processing apparatus that manages a plurality of first units separable from vehicles respectively owned by a plurality of users, capable of autonomous drive, and each capable of being coupled to a second unit having space for accommodating baggage. The control unit is configured to acquire first unit information containing information on a non-use period that is a period during which the first unit is not scheduled to be used by the user, for each of the plurality of first units, acquire second unit information containing information on the number of the second units to be used in delivery of baggage in a predetermined period, and select, from among the plurality of first units, the first unit to be coupled to the second unit for use in delivery of baggage in the predetermined period based on the first unit information and the second unit information.

A second aspect of the disclosure relates to an information processing method that is executed by a computer that manages a plurality of first units separable from vehicles respectively owned by a plurality of users, capable of autonomous drive, and each capable of being coupled to a second unit having space for accommodating baggage.

The information processing method includes acquiring first unit information containing information on a non-use period that is a period during which the first unit is not scheduled to be used by the user, for each of the plurality of first units; acquiring second unit information containing information on the number of the second units to be used in delivery of baggage in a predetermined period; and selecting, from among the plurality of first units, the first unit to be coupled to the second unit for use in delivery of baggage in the predetermined period based on the first unit information and the second unit information.

A third aspect of the disclosure relates to a system. The system includes an information processing apparatus and a plurality of user terminals respectively associated with a plurality of users. The information processing apparatus is configured to manage a plurality of first units separable from vehicles respectively owned by the plurality of users and capable of autonomous drive. The plurality of user terminals each is configured to send, to the information processing apparatus, first unit information containing information on a non-use period that is a period during which the first unit is not scheduled to be used by the user, for each of the plurality of first units. Each first unit is capable of being coupled to a second unit having space for accommodating baggage. The information processing apparatus is configured to, based on the first unit information received from the plurality of user terminals and second unit information containing information on the number of the second units to be used in delivery of baggage in a predetermined period, select, from among the plurality of first units, the first unit to be coupled to the second unit for use in delivery of baggage in the predetermined period.

According to the disclosure, it is possible to effectively use first units, separable from vehicles respectively owned by users and capable of autonomous drive, for delivery of baggage.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the schematic configuration of a delivery system;

FIG. 2 is a view showing coupling and separation of a first unit and a second unit;

FIG. 3 is a block diagram schematically showing an example of the functional configuration of a drive management server;

FIG. 4 is a table showing an example of the table configuration of second unit information;

FIG. 5 is a table showing an example of the table configuration of first unit information stored in a first unit information database;

FIG. 6 is a flowchart for a selecting process; and

FIG. 7 is a flowchart for a notification process.

### DETAILED DESCRIPTION OF EMBODIMENTS

An information processing apparatus according to a first aspect of the disclosure is an information processing apparatus that manages a plurality of first units. The first units are mobile units separable from vehicles respectively owned by a plurality of users. The first units are mobile units capable of autonomous drive. Each first unit is capable of being coupled to a second unit having space for accommodating baggage. When the first unit is coupled to the second unit, the first unit is able to drive while accommodating baggage in the second unit. In other words, when the first unit is coupled to the second unit, the first unit is able to deliver baggage.

A control unit included in the information processing apparatus according to the first aspect of the disclosure is configured to acquire first unit information containing information on a non-use period, for each of the plurality of first units. The non-use period is a period during which the first unit is not scheduled to be used by the user who owns the first unit. The control unit is configured to acquire second unit information. The second unit information contains information on the number of the second units to be used in delivery of baggage in a predetermined period. In this way, the control unit acquires the first unit information and the second unit information, so the control unit is able to grasp the first units not scheduled to be used during the predetermined period, and the number of the second units needed to deliver baggage during the predetermined period, that is, the number of the second units needed to be coupled to the first units.

The control unit is configured to, based on the first unit information and the second unit information, select, from among the plurality of first units, the first unit to be coupled to the second unit for use in delivery of baggage in the predetermined period. Thus, the first units not scheduled to be used in the predetermined period are able to be used for delivery of baggage. As a result, it is possible to effectively use the first units for delivery of baggage.

Hereinafter, a specific embodiment of the disclosure will be described with reference to accompanying drawings. The dimensions, materials, and shapes of components described in the present embodiment, the arrangement of the components, and the like do not intend to limit the technical scope of the disclosure to them unless otherwise specified.

### First Embodiment

### Outline of System

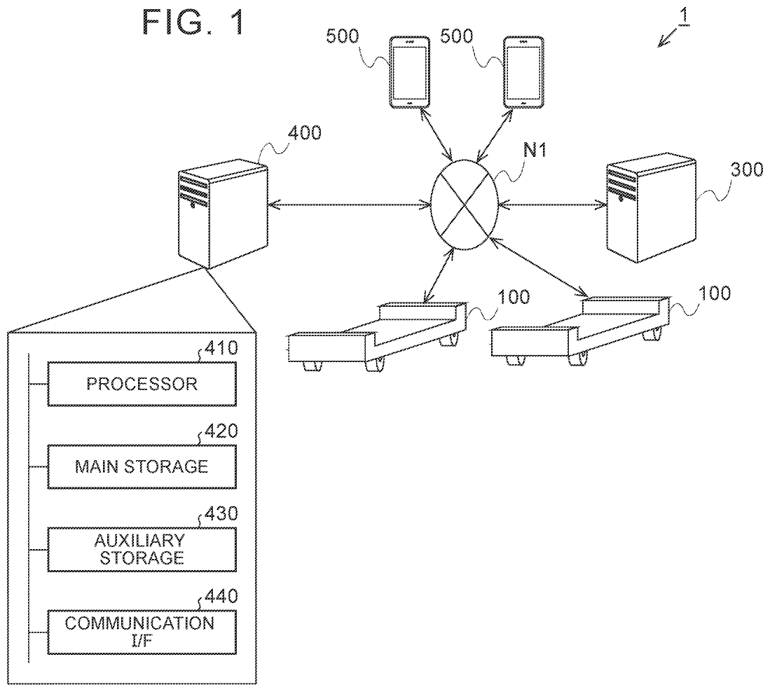

A delivery system 1 according to the present embodiment will be described with reference to FIG. 1. FIG. 1 is a diagram showing the schematic configuration of the delivery system 1. The delivery system 1 includes a plurality of first units 100, a delivery management server 300 that manages delivery of baggage, a drive management server 400 that manages drive of the plurality of first units 100, and user terminals 500 respectively associated with users of the first units 100. Smartphones, mobile information terminals, computers, or the like, owned by the users, may be illustrated as the user terminals 500.

In the delivery system 1, the first units 100, the delivery management server 300, the drive management server 400, and the user terminals 500 are connected to one another by a network N1. Wide Area Network (WAN) that is a worldwide public telecommunication network, such as the Internet, or a telephone communication network, such as a mobile telephone network, may be employed as the network N1.

### First Unit

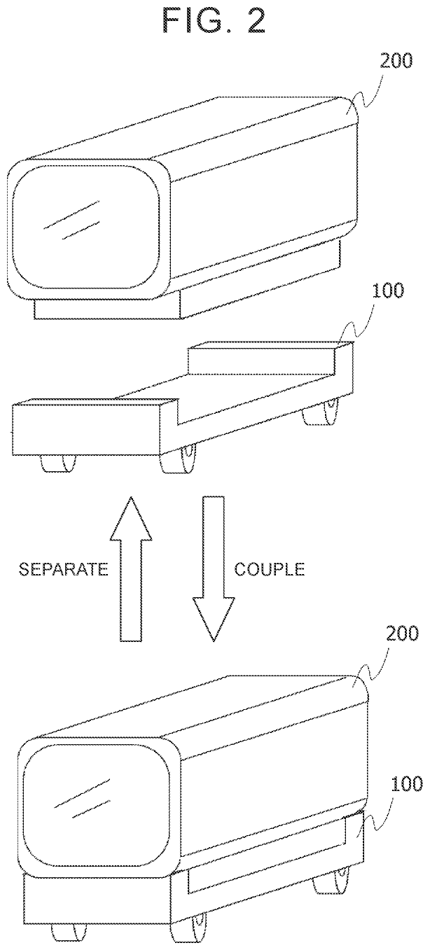

The first units 100 of which drive is managed by the drive management server 400 will be described first with reference to FIG. 2. FIG. 2 is a view showing coupling and separation of the first unit 100 and the second unit 200. The first units 100 are mobile units capable of autonomous drive. The first units 100 each may perform autonomous drive by, for example, generating information to control a drive unit in the first unit 100 for itself. Alternatively, the first units 100 each may perform autonomous drive by, for example, receiving information to control the drive unit in the first unit 100 from the drive management server 400.

The second units 200 are units each having space for accommodating baggage. The second units 200 each are capable of being coupled to the top of the first unit 100. The second units 200 each are also capable of being separated from the top of the first unit 100. In other words, the first unit 100 and the second unit 200 are capable of being coupled to and separated from each other in an up-down direction. Containers or the like may be illustrated as the second units 200. When the first unit 100 is coupled to the second unit 200, the first unit 100 is able to perform drive while accommodating baggage in the coupled second unit 200. In this way, the first units 100 each are able to be used for delivery of baggage when coupled to the second unit 200. The second units 200 include multiple different sizes of second units 200. An amount of available baggage varies among the different-size second units 200. A large size, a medium size, a small size, and the like may be illustrated as the sizes of the second units 200.

The first units 100 each are usually used by a user who owns a vehicle (that is, a user of the first unit 100) as the vehicle in which the first unit 100 and a unit other than the second unit 200 are coupled. Here, a unit having space for accommodating passengers or a unit having space for accommodating baggage, different from the second unit 200, may be illustrated as a unit that a user couples to the first unit 100 and uses in the vehicle. When the first unit 100 is used for delivery of baggage, the first unit 100 is separated from the vehicle owned by the user. Then, the first unit 100 separated from the vehicle owned by the user is coupled to the second unit 200.

A method of coupling and separating the first unit 100 and the second unit 200 is not limited to a specific method. For example, coupling using a bolt may be employed as coupling of the first unit 100 and the second unit 200. In this case, the first unit 100 and the second unit 200 are separated from each other by removing the bolt. For example, coupling using an electromagnet may be employed as coupling of the first unit 100 and the second unit 200. In this case, the first unit 100 and the second unit 200 are separated from each other by stopping energization of the electromagnet.

### Delivery Management Server

The delivery management server 300 is a server that manages delivery of baggage. The delivery management server 300 acquires baggage information containing the size and delivery date and time of each piece of baggage to be delivered. Baggage information is input by, for example, a delivery company that delivers baggage.

A delivery company owns a plurality of the second units 200 for accommodating pieces of baggage to be delivered. However, the delivery company does not own the first units 100 and borrow the first units 100 needed to deliver baggage from users who own the first units 100. In other words, the delivery company delivers baggage by coupling the second units 200 owned by the delivery company to the first units 100 borrowed from the users.

Therefore, the delivery management server 300 generates second unit information containing the size of each of the second units 200 and the number of the second units 200 for each size of the second units 200, to be used for delivery of baggage in a predetermined period based on baggage information. Here, the predetermined period is a period during which baggage is delivered. A known method may be employed as a method in which the delivery management server 300 calculates the size of each of the second units 200 and the number of the second units 200 for each size of the second units 200, to be used in delivery of baggage based on baggage information.

### Drive Management Server

The drive management server 400 shown in FIG. 1 is a server that manages drive of the plurality of first units 100. The drive management server 400 includes a computer including a processor 410, main storage 420, auxiliary storage 430, and a communication interface (communication I/F) 440. The processor 410 is, for example, a central processing unit (CPU) or a digital signal processor (DSP). The main storage 420 is, for example, random access memory (RAM). The auxiliary storage 430 is, for example, read only memory (ROM). The auxiliary storage 430 is also, for example, a hard disk drive (HDD) or a disk recording medium, such as a CD-ROM, a DVD disc, and a Blu-ray Disc. The auxiliary storage 430 may be a removable medium (portable storage medium). For example, a USB flash drive or an SD card is illustrated as a removable medium. The communication I/F 440 is, for example, a local area network (LAN) interface board or a wireless communication circuit for wireless communication.

In the drive management server 400, an operating system (OS), various programs, various information tables, and the like are stored in the auxiliary storage 430. In the drive management server 400, the processor 410 is capable of implementing various functions as will be described later by loading the programs stored in the auxiliary storage 430 onto the main storage 420 and then running the loaded programs. Part or all of the functions in the drive management server 400 may be implemented by a hardware circuit, such as an ASIC and an FPGA. The drive management server 400 does not necessarily need to be implemented by a single physical component and may be made up of a plurality of computers that cooperate with each other. The delivery management server 300 and the user terminals 500 each also include a computer as well as the drive management server 400.

The drive management server 400 manages drive of the plurality of first units 100. The drive management server 400 receives, from each of the user terminals 500, first unit information containing information on a period during which the user of each of the plurality of first units 100 does not use the own first unit 100 (hereinafter, which may be referred to as non-use period). The first unit information is sent to the drive management server 400 when the user of the first unit 100 operates the user terminal 500. In the present embodiment, the drive management server 400 may be regarded as the information processing apparatus in the first aspect of the disclosure. The drive management server 400 also receives second unit information from the delivery management server 300. Thus, the drive management server 400 is able to grasp the size and number of the second units 200 needed to deliver baggage in a predetermined period.

The drive management server 400 selects, from among the plurality of first units 100, the first unit 100 to be coupled to the second unit 200 for use in delivery of baggage in a predetermined period based on the first unit information and the second unit information. Here, the first unit 100 that is selected from among the plurality of first units 100 for use in delivery of baggage is the first unit 100 that is not scheduled to be used by the user in the predetermined period.

In other words, in a period other than the non-use period, the user of each of the plurality of first units 100 uses the first unit 100 as a vehicle by coupling the first unit 100 to a unit other than the second unit 200. When a delivery company needs the first unit 100 to deliver baggage in a predetermined period, the first unit 100 not scheduled to be used by the user in the predetermined period, that is, the first unit 100 for which the predetermined period is included in the non-use period, is selected and borrowed by the delivery company. The delivery company that has borrowed the first unit 100 is able to use the first unit 100 for delivery of baggage by coupling the first unit 100 to the second unit 200.

### System Configuration

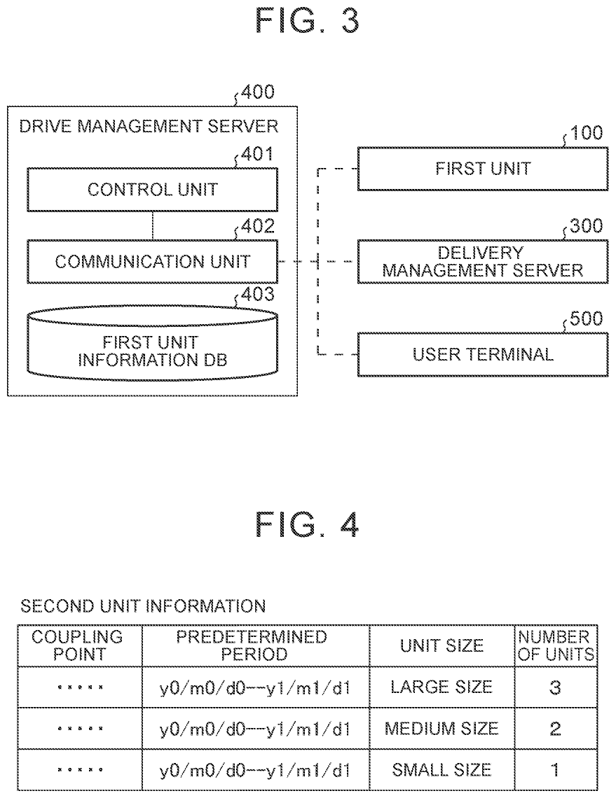

Next, the functional configuration of the drive management server 400 that makes up the delivery system 1 according to the present embodiment will be described with reference to FIG. 3. FIG. 3 is a block diagram schematically showing an example of the functional configuration of the drive management server 400. The drive management server 400 includes a control unit 401, a communication unit 402, and a first unit information database (first unit information DB) 403. The control unit 401 has a function to execute arithmetic processing for controlling the drive management server 400. The control unit 401 is implemented by the processor 410.

The communication unit 402 has a function to connect the drive management server 400 to the network N1. The communication unit 402 is implemented by the communication I/F 440. The control unit 401 communicates with the first units 100, the delivery management server 300, and the user terminals 500 via the communication unit 402.

The control unit 401 receives second unit information from the delivery management server 300 via the communication unit 402. FIG. 4 is a table showing an example of the table configuration of second unit information. As shown in FIG. 4, the second unit information table has a coupling point field, a predetermined period field, a unit size field, and a number field. Information on a coupling point for coupling a first unit 100 to a second unit 200 is entered in the coupling point field. A warehouse or the like storing baggage to be delivered by a delivery company may be illustrated as a coupling point. Information on a predetermined period is entered in the predetermined period field. Information on the size of the second unit 200 that is used to deliver baggage in the predetermined period is entered in the unit size field. Information on the number of second units 200 that are used to deliver baggage in the predetermined period is entered in the number field for each size of the second units 200.

For example, in the example of second unit information shown in FIG. 4, like three large-size second units 200, two medium-size second units 200, and one small-size second unit 200, the size of each second unit 200 to be used for delivery of baggage in a predetermined period and the number of second units 200 to be used for each size are associated with each other.

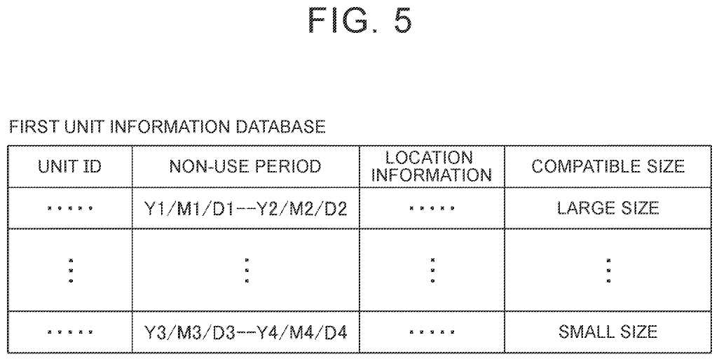

The control unit 401 receives first unit information from each user terminal 500 via the communication unit 402. The control unit 401 stores the received first unit information in the first unit information DB 403. The first unit information DB 403 may be implemented by the auxiliary storage 430. FIG. 5 is a table showing an example of the table configuration of first unit information stored in the first unit information DB 403. As shown in FIG. 5, the first unit information table has a unit ID field, a non-use period field, a location information field, and a compatible size field. An identifier for identifying each first unit 100 is entered in the unit ID field. A non-use period of the first unit 100 associated with each unit ID is entered in the non-use period field. Information on a location in the non-use period of each first unit 100 is entered in the location information field. Information on a location in the non-use period of each first unit 100 is, for example, location information of a place where the user parks the own first unit 100 during the non-use period (a parking place or the like of a vehicle including the first unit 100).

The size of the second unit 200 capable of being coupled to the first unit 100 is determined in advance for each of the first units 100. The compatible size field contains information indicating the size of the second unit 200 capable of being coupled to each first unit 100.

The control unit 401 selects the first unit 100 to be coupled to the second unit 200 for use in delivery of baggage in a predetermined period based on the first unit information on each first unit 100, stored in the first unit information DB 403, and the second unit information received from the delivery management server 300. A method in which the control unit 401 selects the first unit 100 will be described later.

The control unit 401 further sends drive information to the first unit 100 selected by the control unit 401 via the communication unit 402. The drive information contains information on timing at which the first unit 100 starts autonomous drive to a coupling point, and information for causing the first unit 100 to perform autonomous drive to the coupling point. Timing at which the first unit 100 starts autonomous drive to a coupling point is determined based on information on a predetermined period, contained in the second unit information. Also, timing at which the first unit 100 starts autonomous drive to a coupling point is included in the non-use period of the first unit 100.

Information containing a scheduled travel route from a place where the user parks the own first unit 100 to a coupling point may be an example of the information for causing the first unit 100 to perform autonomous drive to a coupling point. Alternatively, information for causing the first unit 100 to perform autonomous drive to a coupling point may be information to control the drive unit in the first unit 100. In this case, the first unit 100 performs autonomous drive based on information to control the drive unit, received from the drive management server 400. In this way, when the control unit 401 sends drive information to the first unit 100, the first unit 100 is able to perform autonomous drive to a coupling point.

### Selecting Process

Next, a selecting process that is executed by the control unit 401 in the drive management server 400 in the delivery system 1 will be described with reference to FIG. 6. FIG. 6 is a flowchart for the selecting process. The selecting process is a process in which the control unit 401 selects the first unit 100 to be borrowed by a delivery company from the user in order to couple the first unit 100 to the second unit 200 for use in delivery of baggage. The selecting process is executed when the drive management server 400 receives second unit information sent from the delivery management server 300.

In the selecting process, initially, in S101, second unit information received from the delivery management server 300 via the communication unit 402 is acquired. Subsequently, in S102, first unit information on each first unit 100 is acquired from the first unit information DB 403. In S103, the first unit 100 to be coupled to the second unit 200 for use in delivery of baggage in a predetermined period is selected from among the plurality of first units 100 based on the first unit information on each first unit 100, and the second unit information.

Here, in S103, the first units 100 each compatible with the size of the second unit 200 in the second unit information are selected in number associated with the size. For example, in the example shown in FIG. 3, it is assumed that the second unit information contains three large-size second units 200, two medium-size second units 200, and one small-size second unit 200. In this case, the control unit 401 selects three first units 100 compatible with the large-size second units 200, two first units 100 compatible with the medium-size second units 200, and a first unit 100 compatible with the small-size second unit 200 based on the information entered in the compatible size field in the first unit information DB 403.

The number of the first units 100 compatible with each size of the second units 200 in the first unit information may be greater than the number of the second units 200 compatible with each size of the second units 200 in the second unit information. In this case, the first unit 100 of which the location indicated by the location information stored in the location information field of the first unit information is close to a coupling point may be preferentially selected over the first unit 100 of which the location is far from the coupling point. By selecting the first unit 100 to be coupled to the second unit 200 for use based on location information in this way, it is possible to reduce a distance from a place where the user parks the own first unit 100 to a coupling point, that is, a movement distance of the first unit 100 to a coupling point. In this way, by reducing the movement distance of the first unit 100, it is possible to reduce time taken to move the first unit 100 and energy consumed during movement.

After the process of S103, when the selecting process ends, the control unit 401 sends the drive information to the first units 100 selected in S103 via the communication unit 402.

As described above, the drive management server 400 selects the first units 100 to be coupled to the second units 200 from among the plurality of first units 100.

Thus, a delivery company is able to borrow the first units 100 not scheduled to be used in a predetermined period from the users and use the borrowed first units 100 for use in delivery of baggage. In this way, with the delivery system 1, it is possible to effectively use the first units 100 for delivery of baggage.

### Modifications

In the present embodiment, the second units 200 have multiple different sizes. Alternatively, the second units 200 may be units having the same size. In this case, the second unit information does not need to contain information on the size of each second unit 200 for use in delivery of baggage in a predetermined period. The first unit information does not need to contain information indicating the size of each second unit 200 capable of being coupled to the first unit 100.

In the present embodiment, the first units 100 in the same number as the number of the second units 200 designated by the second unit information are selected from among the plurality of first units 100. However, when the first unit 100 is capable of being coupled to a plurality of the second units 200, the first unit 100 may be coupled to a plurality of the second units 200 at the time of delivery of baggage. In this case, the number of second units 200 capable of being coupled to each first unit 100 is further contained in the first unit information in association with each size of the second units 200. The control unit 401 may calculate the number of first units 100 to be coupled to the second units 200 for use from the size and number of the second units 200 to be used for delivery of baggage in the second unit information.

In the present embodiment, as shown in FIG. 2, the first unit 100 and the second unit 200 are coupled to each other in the up-down direction. Alternatively, as long as the first unit 100 and the second unit 200 are usable for delivery of baggage when coupled to each other, coupling of the first unit 100 and the second unit 200 is not limited to coupling in the up-down direction. The second unit 200 may be coupled to, for example, the rear of the first unit 100.

The drive management server 400 may be integrated with the delivery management server 300 as a single server.

### Second Embodiment

The drive management server 400 in the present embodiment, different from the first embodiment, executes a notification process to notify the user of the first unit 100 selected by the drive management server 400 that the first unit 100 is borrowed. Hereinafter, only the difference from the first embodiment will be described.

### Notification Process

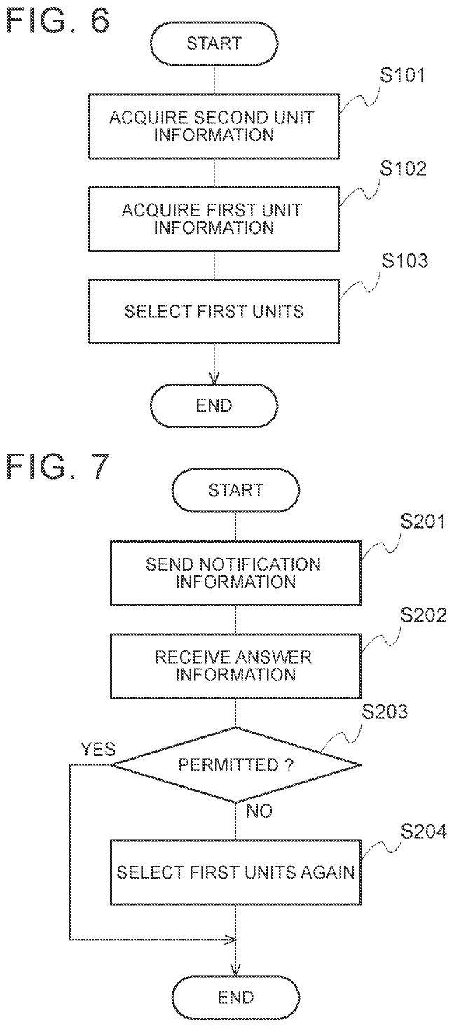

The notification process that is executed by the control unit 401 in the drive management server 400 will be described with reference to FIG. 7. FIG. 7 is a flowchart for the notification process. The notification process is executed by the drive management server 400 after the selecting process shown in FIG. 6. In the notification process, initially, in S201, notification information is sent via the communication unit 402 to the user terminals 500 of all the users of the first units 100 selected in the process of S103 in FIG. 6. The notification information is information for notifying that a delivery company couples the first unit 100 to the second unit 200 for use in delivery of baggage in a predetermined period. In other words, the notification information is information for asking the user to borrow the first unit 100 in a predetermined period. In this case, the user who has received the notification information sends via the user terminal 500 answer information for answering whether to permit the first unit 100 of the user to be coupled to the second unit 200 for use in delivery of baggage.

Subsequently, in S202, answer information is received from the user terminal 500 of the user who has received the notification information. After that, in S203, it is determined based on the answer information whether all the users who have received the notification information permit a use of the first units 100. When affirmative determination is made in S203, the notification process ends. Then, drive information is sent to the first units 100 selected in the process of S103 in FIG. 6.

When negative determination is made in S203, the first units 100 to be coupled to the second units 200 for use in delivery of baggage in a predetermined period are selected again from among the plurality of first units 100 other than the first units 100 of the users who do not permit the first units 100 to be coupled to the second units 200 for use in delivery of baggage based on the first unit information. Then, the notification process once ends. The notification process is executed again on the user terminals 500 of all the users of the first units 100 selected again in S204. In other words, the notification process is repeatedly executed until all the users of the first units 100 selected (selected again) by the control unit 401 permit a use of the first units 100.

As described above, the delivery management server 300 in the present embodiment sends notification information to the user terminals 500 of the users of the first units 100 when the first units 100 are selected. Therefore, when there arises a schedule to use the first unit 100 (vehicle) in the non-use period input to the drive management server 400 by the user at the point in time when notification information is received, the user is able to reject a use of the own first unit 100 to deliver baggage. Thus, it is possible to reduce a situation in which the first unit 100 is borrowed when the user uses the first unit 100.

### Other Embodiments

The above-described embodiments are only illustrative, and the disclosure can be implemented with modifications as needed without departing from the purport of the disclosure. The processes and devices described in this disclosure may be freely implemented in combination without any technical contradiction.

A process described as the one executed by a single apparatus may be shared and executed by a plurality of apparatuses. Alternatively, processes described as the ones executed by different apparatuses may be executed by a single apparatus. In a computer system, what hardware configuration (server configuration) implements functions may be flexibly changed.

The disclosure may also be implemented as follows. A computer is supplied with a computer program having the functions described in the above-described embodiments, and one or more processors of the computer read out and run the program. Such a computer program may be provided to a computer with a non-transitory computer-readable storage medium connectable to a system bus of the computer or may be provided to a computer via a network. Examples of the non-transitory computer-readable storage medium include a disk or disc of any type, such as a magnetic disk (floppy (registered trademark) disk, a hard disk drive (HDD), or the like), an optical disc (a CD-ROM, a DVD disc, a Blue-ray disc, or the like), read only memory (ROM), random access memory (RAM), EPROM, EEPROM, a magnetic card, flash memory, an optical card, and a medium of any type suitable for storing electronic instructions.

What is claimed is:

1. An information processing apparatus that manages a plurality of first units separable from vehicles respectively owned by a plurality of users, capable of autonomous drive, and each capable of being coupled to a second unit having space for accommodating baggage, the information processing apparatus comprising:
a control unit configured to
acquire first unit information containing information on a non-use period that is a period during which the first unit is not scheduled to be used by the user, for each of the plurality of first units,
acquire second unit information containing information on the number of the second units to be used in delivery of baggage in a predetermined period, and
select, from among the plurality of first units, the first unit to be coupled to the second unit for use in delivery of baggage in the predetermined period based on the first unit information and the second unit information.

2. The information processing apparatus according to claim 1, wherein:
the first unit information further contains information on a size of the second unit capable of being coupled to each of the plurality of first units;
the second unit information further contains information on a size of each of the second units to be used in delivery of baggage in the predetermined period; and
the control unit is configured to select, from among the plurality of first units, the first unit compatible with the size of each second unit to be used in delivery of baggage in the predetermined period.

3. The information processing apparatus according to claim 1, wherein:
the first unit information contains location information on a location of each of the plurality of first units in the non-use period;
the second unit information contains information containing a coupling point for coupling the first unit to the second unit; and
the control unit is configured to, based on the location information and the information containing the coupling point, select, from among the plurality of first units, the first unit to be coupled to the second unit for use in delivery of baggage in the predetermined period.

4. The information processing apparatus according to claim 1, wherein the control unit is configured to send notification information notifying that the first unit is coupled to the second unit for use in delivery of baggage in the predetermined period, to a specified user terminal associated with the user of the selected first unit.

5. The information processing apparatus according to claim 4, wherein the control unit is configured to, when the user of the specified user terminal that has received the notification information does not permit a use of the first unit, select again, from among the plurality of first units, the first unit to be coupled to the second unit for use in delivery of baggage in the predetermined period.

6. The information processing apparatus according to claim 1, wherein the control unit is configured to acquire the first unit information from a user terminal associated with the user of each of the plurality of first units.

7. The information processing apparatus according to claim 1, wherein the control unit is configured to, based on the second unit information, calculate the number of the first units to be coupled to the second units for use in delivery of baggage in the predetermined period.

8. The information processing apparatus according to claim 1, wherein the number of the second units, contained in the second unit information, is calculated based on baggage information containing a size of each piece of baggage to be delivered in the predetermined period.

9. The information processing apparatus according to claim 2, wherein the size of each of the second units, contained in the second unit information, is calculated based on baggage information containing a size of each piece of baggage to be delivered in the predetermined period.

10. The information processing apparatus according to claim 1, wherein:
the second unit information contains information containing a coupling point for coupling the first unit to the second unit; and
the control unit is configured to send, to the selected first unit, information on timing at which the selected first unit starts autonomous drive to the coupling point and information used to cause the selected first unit to perform autonomous drive to the coupling point.

11. An information processing method that is executed by a computer that manages a plurality of first units separable from vehicles respectively owned by a plurality of users, capable of autonomous drive, and each capable of being coupled to a second unit having space for accommodating baggage, the information processing method comprising:
acquiring first unit information containing information on a non-use period that is a period during which the first unit is not scheduled to be used by the user, for each of the plurality of first units;
acquiring second unit information containing information on the number of the second units to be used in delivery of baggage in a predetermined period; and
selecting, from among the plurality of first units, the first unit to be coupled to the second unit for use in delivery of baggage in the predetermined period based on the first unit information and the second unit information.

12. The information processing method according to claim 11, wherein:
the first unit information further contains information on a size of the second unit capable of being coupled to each of the plurality of first units;
the second unit information further contains information on a size of each of the second units to be used in delivery of baggage in the predetermined period; and
the first unit compatible with the size of each of the second units to be used in delivery of baggage in the predetermined period is selected from among the plurality of first units.

13. The information processing method according to claim 11, wherein:
the first unit information contains location information on a location of each of the plurality of first units in the non-use period;
the second unit information contains information containing a coupling point for coupling the first unit to the second unit; and
based on the location information and the information containing the coupling point, the first unit to be coupled to the second unit for use in delivery of baggage in the predetermined period is selected from among the plurality of first units.

14. The information processing method according to claim 11, further comprising sending notification information notifying that the first unit is coupled to the second unit for use in delivery of baggage in the predetermined period, to a specified user terminal associated with the user of the selected first unit.

15. The information processing method according to claim 14, further comprising, when the user of the specified user terminal that has received the notification information does not permit a use of the first unit, selecting again, from among the plurality of first units, the first unit to be coupled to the second unit for use in delivery of baggage in the predetermined period.

16. A system comprising:
an information processing apparatus; and
a plurality of user terminals respectively associated with a plurality of users, wherein:
the information processing apparatus is configured to manage a plurality of first units separable from vehicles respectively owned by the plurality of users and capable of autonomous drive;
the plurality of user terminals each is configured to send, to the information processing apparatus, first unit information containing information on a non-use period that is a period during which the first unit is not scheduled to be used by the user, for each of the plurality of first units;
each first unit is capable of being coupled to a second unit having space for accommodating baggage; and
the information processing apparatus is configured to, based on the first unit information received from the plurality of user terminals and second unit information containing information on the number of the second units to be used in delivery of baggage in a predetermined period, select, from among the plurality of first units, the first unit to be coupled to the second unit for use in delivery of baggage in the predetermined period.

17. The system according to claim 16, wherein:
the first unit information further contains information on a size of the second unit capable of being coupled to each of the plurality of first units;
the second unit information further contains information on a size of each of the second units to be used in delivery of baggage in the predetermined period; and
the information processing apparatus is configured to select, from among the plurality of first units, the first unit compatible with the size of each of the second units to be used in delivery of baggage in the predetermined period.

18. The system according to claim 16, wherein:
the first unit information contains location information on a location of each of the plurality of first units in the non-use period;
the second unit information contains information containing a coupling point for coupling the first unit to the second unit; and
the information processing apparatus is configured to, based on the location information and the information containing the coupling point, select, from among the plurality of first units, the first unit to be coupled to the second unit for use in delivery of baggage in the predetermined period.

19. The system according to any one of claim 16, wherein the information processing apparatus is configured to send notification information notifying that the first unit is coupled to the second unit for use in delivery of baggage in the predetermined period, to a specified user terminal associated with the user of the selected first unit among the plurality of user terminals.

20. The system according to claim 19, wherein the information processing apparatus is configured to, when the user of the specified user terminal that has received the notification information does not permit a use of the first unit, select again, from among the plurality of first units, the first unit to be coupled to the second unit for use in delivery of baggage in the predetermined period.
